(19) United States
(12) Patent Application Publication
(10) Pub. No.: US 2007/0268283 A1
(43) Pub. Date: Nov. 22, 2007

(54) POWER CONTROLLER FOR DISPLAY DEVICE AND ELECTRONIC APPARATUS UTILIZING THE SAME

(75) Inventors: He-Li Wang, Shenzhen (CN); Jun-Feng Mao, Shenzhen (CN); Hua-Qing Liu, Shenzhen (CN); Yen-Wen Wang, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,789

(22) Filed: Sep. 27, 2006

(30) Foreign Application Priority Data
May 19, 2006 (CN) 200610060748.6

(51) Int. Cl. G09G 5/00

(52) U.S. Cl. 345/211

(57) ABSTRACT

A power controller, which is used for a pivotable display device, includes an actuator configured so as to be fixed with respect to a rotating axis of the display device; and a toggle switch configured for controlling electric power of the display device. The toggle switch is configured so as to be fixed to the display device, and includes a switch body and a toggle lever. The toggle lever rockably extends from the switch body for being pushed by the actuator to cut off electric power of the display device at a predetermined position of the display device.

### 1. FIELD OF THE INVENTION

The present invention generally relates to display devices and, more particularly, to a power controller for a display device, which cuts off power to the display device, when the display device reaches a certain angular position relative to its base.

### 2. DESCRIPTION OF RELATED ART

A portable electronic device such as a notebook computer and a portable disc player, is easy to carry and can be conveniently used anywhere, even at places where no mains power supply is available, by using a battery pack incorporated in the portable electronic device. However, the energy capacity of the battery is limited. Not only does the battery pack have a limited energy capacity, it is also limited in its physical size because of the need for a receiving case to be compact and portable. In most situations, a display of the portable electronic device is powered on when the portable electronic device is in operation, and the display is powered off when the portable electronic device is not in operation. However, during waiting time or stand-by time, the display continues to consume the limited power of the battery pack. This makes energy conservation of the battery an important yew problematic issue.

Certain devices have been developed to solve the above mentioned problem. A power saving circuit and method is applied in a display device. The power saving circuit automatically shuts off power to the display device after a predetermined idle time. However, the power saving circuit is complicated and increases cost. In addition, a control method does not accurately control the power consumed by the display device.

Accordingly, a need exists for a power controller for a display device with a simple configuration and an electronic apparatus utilizing the same in the industry.

### SUMMARY OF THE INVENTION

A power controller, which is used for a pivotable display device, includes an actuator configured so as to be fixed with respect to a rotating axis of the display device; and a toggle switch configured for controlling electric power of the display device. The toggle switch is configured so as to be fixed to the display device, and includes a switch body and a toggle lever. The toggle lever rockably extends from the switch body for being pushed by the actuator to cut off the electric power of the display device at a predetermined position of the display device.

An electronic apparatus includes a main body, a display device pivotably attached to the main body around a rotating axis, a hinge device, and a switch configured for controlling electric power of the display device. The hinge device includes a fixing piece and at least one movable piece rotatable with respect to the fixing piece. The fixing piece is secured to the main body, and the at least one movable piece is secured to the display device. The fixing piece forms an actuator thereon. The switch is fixed to the display device, and is selectively activated by the actuator of the hinge device when the display device pivots.

Other systems, methods, features, and advantages of the present power controller and the present electronic apparatus will be or become apparent to one with skill in the art upon examination of the following drawings and detailed description. It is intended that all such additional systems, methods, features, and advantages be included within this description, be within the scope of the present apparatus, and be protected by the accompanying claims.

### BRIEF DESCRIPTION OF THE DRAWINGS

Many aspects of the present power controller and the present electronic apparatus can be better understood with reference to the following drawings. The components in the drawings are not necessarily to scale, emphasis instead being placed upon clearly illustrating the principles of the present device. Moreover, in the drawings, like reference numerals designate corresponding parts throughout the several views.

FIG. 1 is an isometric view of an electronic apparatus in a closed state according to an exemplary embodiment, the electronic device including a hinge;

FIG. 2 is an enlarged, isometric view of the hinge;

FIG. 3 is an enlarged view of a circled portion III in FIG. 1;

FIG. 4 is an isometric view of the electronic apparatus in an opened state; and

FIG. 5 is an enlarged view of a circled portion V in FIG. 4.

### DETAILED DESCRIPTION OF THE INVENTION

Reference will now be made to the drawings to describe the preferred embodiments of the present power controller and the present electronic apparatus, in detail.

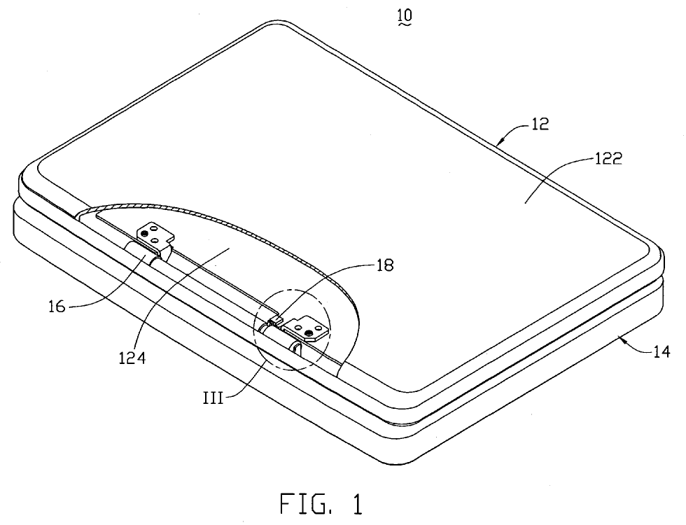

Referring to FIG. 1, an electronic apparatus 10 in accordance with an exemplary embodiment is illustrated. The electronic apparatus 10 includes a display device 12, a main body 14, a hinge device 16, and a toggle switch 18. The display device 12 is pivotably attached to the main body 14 with the hinge device 16. The toggle switch 18 is attached to the display device 12 to control power supplied thereto.

The display device 12 is an information display for visually presenting data images and text of the electronic apparatus 000. The display device 12 is configured to present information dynamically on a visual medium. The display device 12 includes a main frame 122 to protect and secure internal components of the display device 12, a display panel (not shown) installed inside the main frame 122, and a circuit board 124 for controlling operations of the display panel. The circuit board 124 further supplies electric power to the display panel, and controls display properties of the display panel, such as brightness, contrast, et al. The toggle switch 18 is soldered on the circuit board 124, and is electrically coupled to the circuit board 124 for controlling the electric power supplied to the display panel.

The main body 14 is a frame for receiving and securing most components of the electronic apparatus 10. In use, the main body 14 is placed on a table or any other supporting platform, and the display device 12 is rotated around the hinge device 16 to a desired position for viewing.

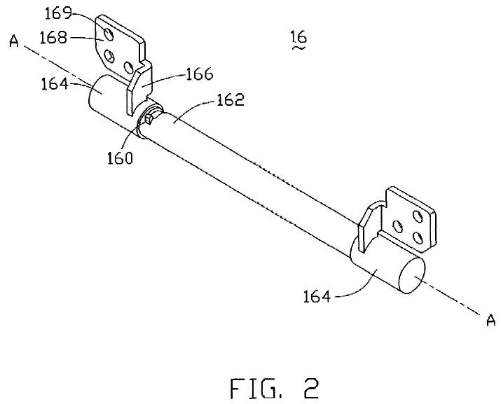

Referring to FIG. 2, a detailed configuration of the hinge device 16 is illustrated. The hinge device 16 includes a shaft 162 and two sleeves 164. Each sleeve 164 is sleeved onto opposite ends of the shaft 152. The shaft 162 is secured to the main body 14 of the electronic apparatus 10, and is a stationary piece of the hinge device 16. The sleeves 164 are movable pieces of the hinge device 16, and are rotatable around a rotating axis M with respect to the shaft 162.

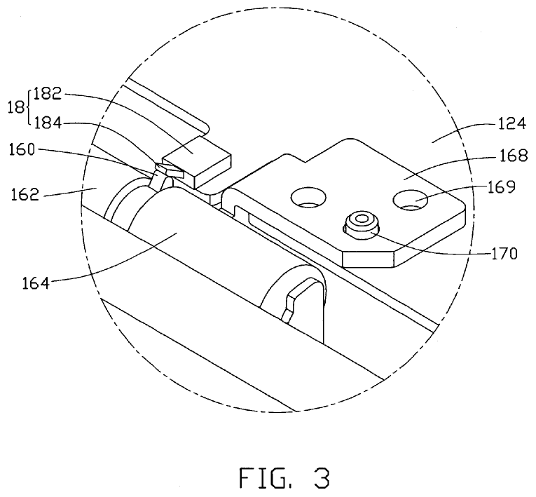

Referring to FIG. 3 together, an actuator 160 is formed on the shaft 162 of the hinge device 16. The actuator 160 extends along a direction perpendicular/radial to the rotating axis M, reaching the toggle switch 18. The toggle switch 18 includes a switch body 182 and a toggle lever 184. The switch body 182 is a main body of the toggle switch 18, and the toggle lever 184 extends from the switch body 182 along a direction perpendicular to the rotating axis M. The toggle lever 184 is rockable with respect to the switch body 182. The toggle lever 184 is reachable by the actuator 160 of the shaft 162, but is unreachable by other portion of the shaft 162.

The toggle switch 18 has two states, a first state and a second state. At rest, when no external forces are applied on the toggle lever 184, the toggle switch 18 is at the first state. At the first state, the toggle switch 18 is said to be “on”, conducting electrical power. When a constant external force is applied to the toggle lever 184, the toggle switch 18 is in the second state and is said to be “off”, not conducting electrical power; when the external force acting upon the toggle lever 184 is released, the toggle switch 18 returns to the first state.

Each sleeve 164 further includes a bracket 166 and a mounting plate 168. Each bracket 166 extends from the sleeve 164 and connects the mounting plate 168 and the sleeve 164. Each mounting plate 168 defines a plurality of mounting holes 168 therein. The mounting plates 168 are secured to the display device 12 by fasteners 170 fastened through the mounting holes 169.

Referring to FIG. 1 to FIG. 3, when the electronic apparatus 10 is in a closed state, the display device 12 is folded down, fully covering on the main body 14. In such state, the actuator 160 resists against the toggle lever 184 of the toggle switch 18, i.e., the toggle lever 184 is being pushed. The toggle switch is in the second state, thus, the electric power to the display device 12 is cut off by the toggle switch 18, and the display device 12 is off.

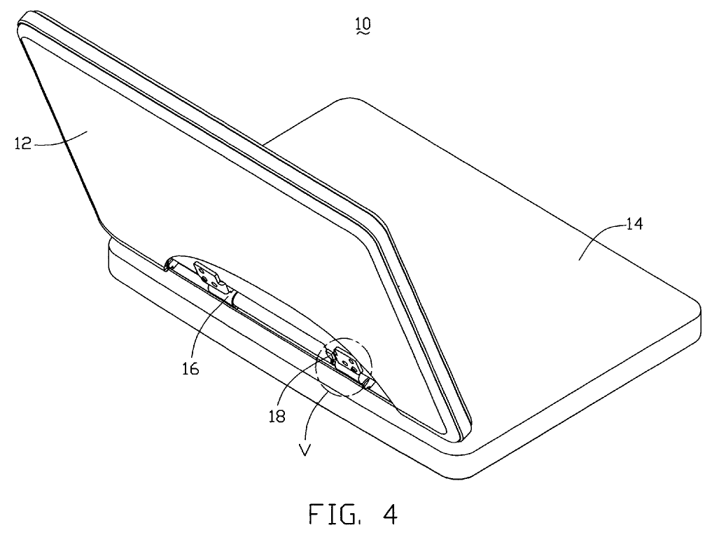

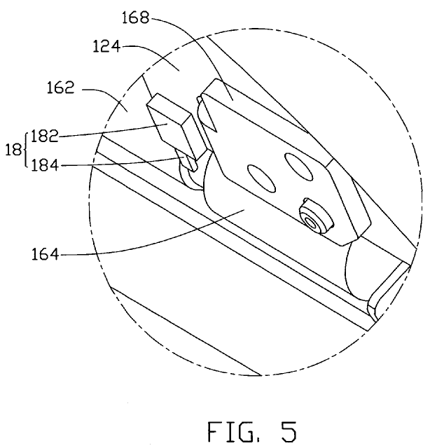

Referring to FIG. 4 and FIG. 5, when opened, the display device 12 is gradually flipped open from the main body 14 with respect to the rotating axis M. As the display device 12 flips open from the main body 14, the movable pieces, i.e. the sleeves 164, the brackets 166, and the mounting plates 168, rotate around the rotating axis M with respect to the shaft 162. The display device 12 moves together with the movable pieces of the hinge device 16. Hence, the toggle switch 18 that is fixed on the display device 12 also moves around the rotating axis M with respect to the shaft 162 and the actuator 160 on the shaft 162. As the toggle switch 18 rotates, the toggle lever 184 thereof gradually leaves the actuator 160. When the toggle lever 184 leaves the actuator 160, hence, the actuator no longer pushes the toggle lever 184 and the toggle switch 18 returns to the first state; i.e. when the display device 12 rotates to a predetermined angular position from the closed state, the toggle switch 18 is turned on and the electric power is supplied to the display device 12 continuously as long as a current angular position of the display device 12 is equal to or greater than the predetermined angular position. Hence, the electronic device 10 is at an opened state and the display device 12 is turned on. The electric power is supplied to the display device 12 continuously, until the instance where the current angular position of the display device 12 becomes smaller than the predetermined angular position, such that the toggle lever 184 of the toggle switch 18 reaches the actuator 160 of the shaft 162. At the angular position smaller than the predetermined angular position, the actuator 160 resists against the toggle lever 184 resulting in the toggle switch 18 to be in the second state.

The display device 12 is connected to the circuit board 124 by the toggle switch 18 that supplies and discontinues the electric power thereof. As the display device 12 rotates around the rotating axis with respect to the main body 14, the toggle lever 184 of the toggle switch 18 selectively communicates with the actuator 160 that is fixed on the shaft 162. The electric power is selectively supplied or discontinued, at different rotating positions of the display device 12 with respect to the main body 14. As the actuator 160 is elongated along the direction perpendicular/radial to the rotating axis M of the shaft 162 reaching the toggle lever 184, this configuration allows space-saving for the electronic apparatus as a whole, especially with display devices with small and compact configurations.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A power controller for a pivotable display device, the power controller comprising:
an actuator being configured so as to be fixed with respect to a rotating axis of the display device; and
a toggle switch configured for controlling electric power of the display device, the toggle switch being configured so as be fixed to the display device and including a switch body and a toggle lever, the toggle lever rockably extending from the switch body for being pushed by the actuator to cut off electric power of the display device at a predetermined position of the display device.

2. The power controller as claimed in claim 1, wherein the actuator extends along a direction perpendicular to the rotating axis of the display device.

3. An electronic apparatus, comprising:
a main body;
a display device pivotably attached to the main body around a rotating axis;
a hinge device including a fixing piece and at least one movable pieces rotatable with respect to the fixing piece, the fixing piece being secured to the main body, the at least one movable piece being secured to the display device, the fixing piece forming an actuator thereon; and
a switch configured for controlling electric power of the display device, the switch being fixed to the display device and being selectively activated by the actuator of the hinge device when the display device pivots.

4. The electronic apparatus as claimed in claim 3, wherein the actuator is formed along a direction perpendicular to the rotating axis.

5. The electronic apparatus as claimed in claim 3, wherein the switch is a toggle switch including a switch body and a toggle lever, and the toggle lever rockably extends from the switch body for switching current state of the toggle switch.

6. The electronic apparatus as claimed in claim 3, wherein the electric power of the display device is cut off, when the switch is activated by the actuator.

7. The electronic apparatus as claimed in claim 3, wherein the fixing device is a shaft sleeved on by the at least one movable piece.

8. The electronic apparatus as claimed in claim 7, wherein each movable piece comprises a sleeve sleeving on the shaft, a bracket extending from the sleeve and a mounting plate extending from the bracket.

9. The electronic apparatus as claimed in claim 8, wherein the mounting plate defines at least one mounting holes therein, and the at least one movable piece is secured to the display device by a fastener through the mounting hole.

10. The electronic apparatus as claimed in claim 3, wherein the display device comprises a circuit board for controlling display parameters thereof.

11. The electronic apparatus as claimed in claim 10, wherein the switch is electrically coupled to the circuit board.

12. The electronic apparatus as claimed in claim 11, wherein the switch is directly soldered on the circuit board.
